(19) United States
(12) Patent Application Publication
(10) Pub. No.: US 2009/0048875 A1
(43) Pub. Date: Feb. 19, 2009

(54) Wedding insurance

(76) Inventors: Jason Schwalbe, New York, NY (US); Jeremy Schwalbe, New York, NY (US)

Correspondence Address: MAIER & MAIER, PLLC, 1000 DUKE STREET, ALEXANDRIA, VA, 22314, US

(21) Appl. No.: 11/889,931

(22) Filed: Aug. 17, 2007

(51) Int. Cl. G06Q 40/00

(52) U.S. Cl. 705/4

(57) ABSTRACT

A method and system of insuring a wedding and determine a premium is disclosed. Wedding insurance insures the events or products associated with the wedding of a couple. In order to administer this insurance the amount of coverage may be determined along with the time period of coverage, the trigger for payout of the insurance and payment schedule of the premium. The premium can be determined by the payment schedule, amount of coverage and the probability of divorce of the couple.

### BACKGROUND

Marriage has been long been a tradition for most civilizations throughout the world. Weddings are held as a celebration of the marriage of a couple. Weddings may vary drastically between couples, religions and cultures. The cost of weddings also varies drastically, from just a few dollars to many thousands or even millions of dollars. Often weddings include a reception hall, catering services, professional pictures, lavish dresses and formal wear, entertainment and decorations.

In the United States the average cost of a wedding is over $25,000 and rising every year. However, depending on the monetary resources of the wedding couple and their families, weddings can be much more extravagant. Geographical location of the wedding may also play a key role in the overall cost of the wedding. For example, procuring a wedding or reception hall in New York or Los Angeles could potentially cost hundreds of thousands of dollars alone. Often, wedding couples or their families take out large debt in the form of credit cards or even home equity lines of credit in order to finance these events. These expenses can place a large burden, however willingly, on the parties who finance the wedding.

Unfortunately, divorce is also prevalent in most areas of the world. Divorce often leaves families heart-broken and devastated. Divorce is common at any stage of marriage and is often difficult, if not impossible, to predict. Most couples enter marriage with the best of intentions and hope for a lifetime of happiness. However, despite grand weddings and admirable intentions there will always be the possibility of a failed marriage and subsequent divorce.

### SUMMARY

An exemplary embodiment discloses a method of insuring a wedding. The method may include administering insurance for events and products associated with a wedding. This insurance may be administered by determining an amount of insurance coverage, which events, products and services will be covered, a time period for the insurance coverage and a trigger for payout of the insurance. A premium may also be collected for the insurance and an insurance agreement may be drafted.

Another exemplary embodiment discloses a method of determining a premium for wedding insurance. The premium may be established by determining a probability of divorce of the married couple, the amount of wedding insurance coverage and a payment schedule for payment of the premium.

Another exemplary embodiment discloses a system for determining a wedding insurance premium. The system may include a computer program configured to receive, as input, an amount of coverage of wedding insurance and a payment schedule for payment of a premium. The computer program may then receive, as input, factors that may affect a probability of divorce of two people, who's wedding is being insured. The computer may take these factors and calculate a probability of divorce. After this computation, the computer program may process the probability, the amount of coverage of wedding insurance and the payment schedule for payment of the premium and calculate the premium amount.

### BRIEF DESCRIPTION OF THE DRAWINGS

Advantages of embodiments of the present invention will be apparent from the following detailed description of the exemplary embodiments thereof, which description should be considered in conjunction with the accompanying drawings in which like numerals indicate like elements, in which:

FIG. 1 is a flow chart depicting an exemplary embodiment of a method of purchasing wedding insurance.

FIG. 2 is a flow chart depicting an exemplary embodiment of a method of determining wedding insurance premiums.

FIG. 3 is a timeline depicting an exemplary embodiment of wedding insurance benefits.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description, discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

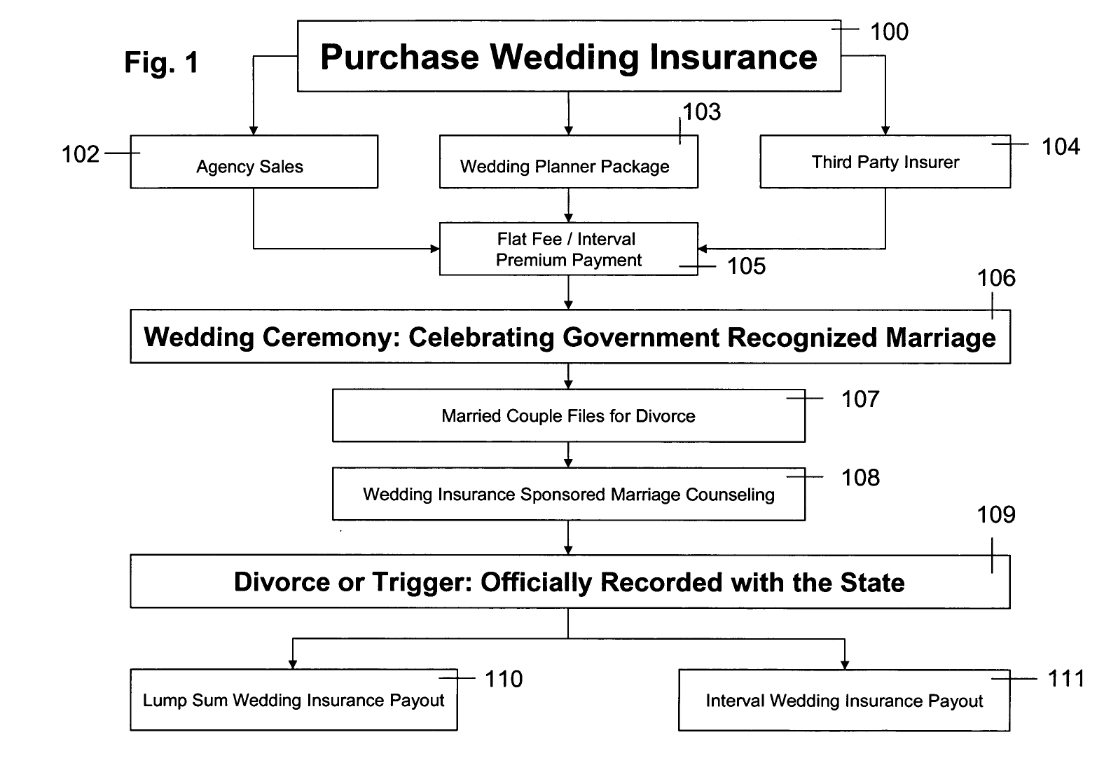

In an exemplary embodiment, as shown in FIG. 1, a method of insuring a wedding ceremony 106 may include insuring any of the events, services or products that may be associated with the wedding 106. Wedding insurance coverage 100 may include, for example, up to the entire cost of a wedding event, service or product or any other predetermined amount. For example, a wedding 106 may include a church, reception hall, catering services, wedding cake, pictures, transportation services, rehearsals, invitations, gifts, dresses, suits and tuxedos, entertainment, flowers, decorations, honeymoon expenses, legal fees incurred during the drafting of a prenuptial agreement and any other desired event, service or product. Each of these events, services and products may range in cost from just a few dollars to many thousands of dollars and may be financed by anyone, including, for example, the married couple, parents of the couple, other relatives, friends or other acquaintances.

This wedding insurance 100 can be purchased by any party that may have provided any financial support to the wedding 106. In another exemplary embodiment, wedding insurance 100 may be purchased on behalf of another party, provided the end holder of the wedding insurance 100 provided financial support for the wedding. Wedding insurance 100 may be purchased directly through an agency 102, through a wedding planner package 103 or from any other available third party insurer 104.

Also in an exemplary embodiment, the wedding insurance payout 110 and 111 may be claimed by the wedding insurance holder in the event of a trigger 109, for example, divorce, dissolution or annulment of the marriage of the couple celebrated at the wedding or the death of one of the wedding parties. However, a benefit of wedding insurance 100 may be, for example, marriage counseling 108, which may be sponsored by the wedding insurance 100. This marriage counseling 108 may be utilized by the married couple after one or both parties file for divorce 107 or at any other time during their marriage. Additionally, wedding insurance 100 may sponsor a match-making or dating service for one or both of the wedding parties in the event of a trigger 109.

The trigger 109 may be established, for example, by the presentation of an official government record or any other applicable documentation. The payout 110 and 111 may be an amount predetermined by the insurer or negotiated by both the insurer and insured party. Additionally, payout 110 and 111 may be made in the form of a lump sum payout 110, interval payout 111 over a predetermined time period or any other desired form.

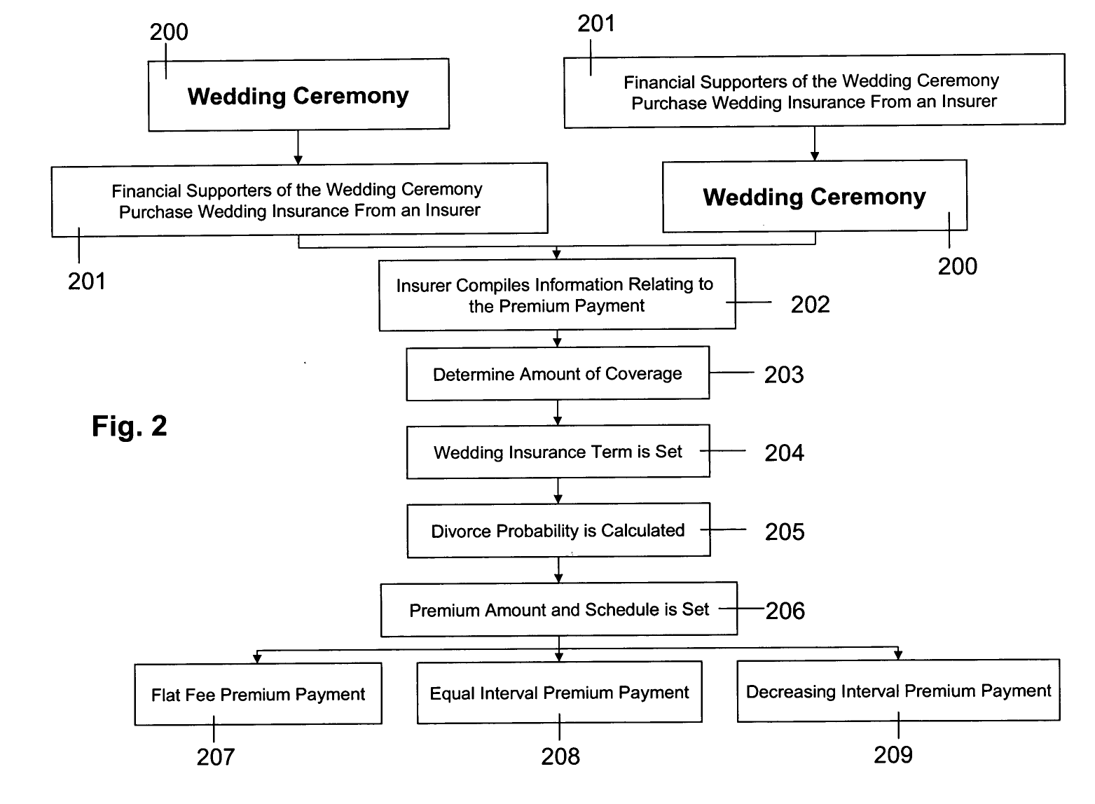

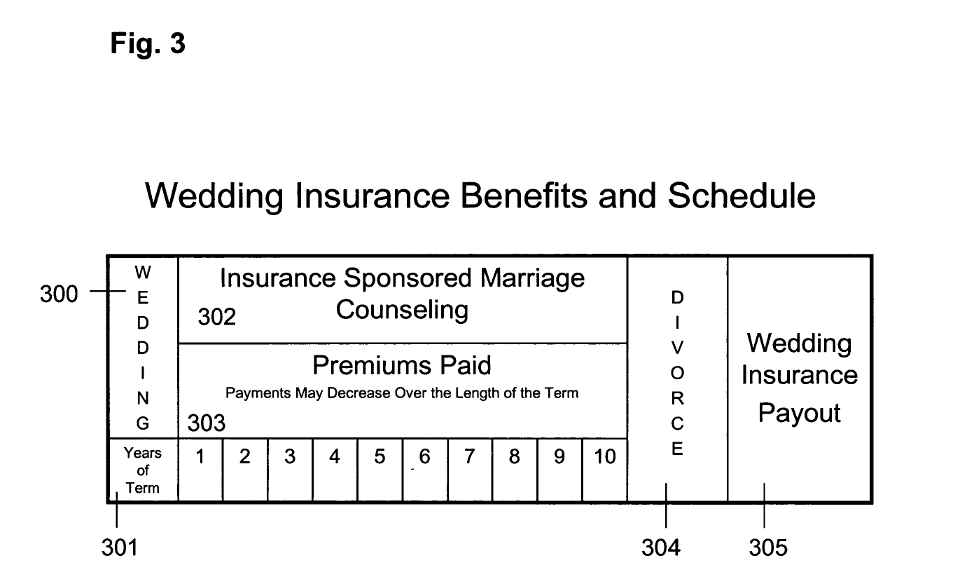

Referring to FIGS. 2 and 3, an insured party may be required to pay a premium 206 and 303 in order to receive the benefit of wedding insurance 201. The premium 206 and 303 may be negotiated by the insurer and the insured party. In one exemplary embodiment the premium 206 and 303 may by paid in periodic intervals of equal payments 208 or decreasing interval payments 209 throughout the term 301 of the insurance coverage, for example, every month, year or any other desired interval. Alternatively, a premium 206 and 303 can be paid as a flat fee 207, either before or after the wedding 200 and 300. In another exemplary embodiment, the term of coverage 204 and 301 of the wedding insurance 201 may be a fixed term, for example 5, 10, 15 years or any other desired term length. The term of coverage 204 and 301 of the wedding insurance 201 may also be an open-ended term that may be renewed with each subsequent premium payment 206 and 303, for example, renewable every month, year or any other desired interval.

Premiums 206 and 303 can be determined or negotiated in a variety of different ways. Premiums 206 and 303 may be affected by the amount of coverage desired 203, term of coverage 204 and 301, the probability of divorce 205 of the married couple and the premium schedule 206.

In an exemplary embodiment, the amount of the premium 206 and 303 may be increased with greater coverage 203 and conversely, if less coverage 203 is desired the amount of the premium 206 and 303 may be less. In another exemplary embodiment, the total amount of the premium 206 and 303 may be reduced if the total amount of the premium 206 and 303 is paid as a flat fee 207. Other exemplary embodiments may include, paying a smaller premium 206 and 303, if payments begin before the wedding 200 and 300. Alternatively, premium payments 206 and 303 may be larger if payments begin after the wedding 200 and 300 and they may increase further if begun farther from the date of the wedding 200 and 300. The total amount of a premium 206 and 303 may also be paid over time, at predetermined intervals. For example, premium payments 208 and 209 may be made in intervals where the premium payments 208 and 209 may increase or decrease with each subsequent payment, or periodically, as the time since the wedding 200 increases.

In another exemplary embodiment premium payments 206 and 303 may continue until the end of the term 204 and 301 or until the trigger 304 occurs. Throughout the term 204 and 301 the married couple may be eligible for marriage counseling 302 until the trigger 304 occurs, resulting in a wedding insurance payout 305.

Premiums 206 and 303 may also be affected by the probability of the married couple getting a divorce 205. Premium 206 and 303 amounts may increase with a higher probability of divorce 205 and reciprocally, premium 206 and 303 amounts may decrease with a lower probability of divorce 205. This probability of divorce 205 may be determined or estimated by analyzing different factors. Factors that be used may in this determination may include, the age of the parties, number of children present in the relationship, previous divorces, cost of the wedding, history of abuse, criminal records, religious affiliation, ethnicity, net worth of the parties, income, debt, mental and physical health, history of divorce of parents, physical or mental handicap of a parent, early or untimely death of a parent, location of residence and any other potential factor in determining the probability of divorce 205. The presence of predetermined factors may potentially increase the probability of divorce 205, and therefore, may increase the amount of the premium 206 and 303.

A wedding insurance agreement may be drafted upon completion of the negotiation of the terms and conditions of the wedding insurance 201. This agreement may include, for example, the names of the wedding couple who's wedding is to be insured, an amount of insurance coverage 203 and which events, products and services are to be covered, a time period 204 and 301 for the insurance coverage 203, a trigger 304 for a payout 305 of the wedding insurance 201 and the amount of the premium 206 and 303 for the insurance. Additionally, the wedding insurance agreement may include any statutory language necessary to enforce the agreement under the applicable state laws.

Generally referring to FIG. 1-3, an exemplary embodiment may include a computer program may be configured to calculate the amount of a premium 105, 206 and 303. The computer program may, for example, receive as input, a desired amount wedding insurance coverage 203 and a desired payment schedule 105 and 206 for payment of the premium 105, 206 and 303. Then the computer program may receive, as input, factors that may affect a probability of divorce 205 of two people, who's wedding 106, 200 and 300 is being insured. The computer program may then process these factors and calculate a probability of divorce 205. Finally, the computer program may process the amount of coverage 203, the term of coverage 204, the probability of divorce 205, and the payment schedule 105 and 206 for payment of the premium 105, 206 and 303 and calculate the premium amount 206 and 303. The premium amount 105, 206 and 303 may then be added to the wedding insurance agreement.

In another exemplary embodiment, the method of administering wedding insurance 100 and 201 utilizing a computer program configured to calculate the premium 206 and 303 may be used by an insurance agency 102, wedding planner 103 or any other third party 104 desiring to provide wedding insurance 100 and 201 for wedding 100, 200, and 300, events, services and products.

The foregoing description and accompanying drawings illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method of insuring a wedding comprising:
administering insurance for events, products and services associated with a wedding for two people;
determining an amount of insurance coverage and which events, services and products will be covered;
determining a time period for the insurance coverage;
determining a trigger for payout of the insurance;
collecting a premium for the insurance from at least one party.

2. The method of insuring a wedding of claim 1, wherein the at least one party provided money for at least one of the events, products and services.

3. The method of insuring a wedding of claim 1, wherein the at least one party is the two people.

4. The method of insuring a wedding of claim 1, wherein the premium is collected as a flat fee before the wedding.

5. The method of insuring a wedding of claim 1, wherein the premium is collected as a flat fee after the wedding.

6. The method of insuring a wedding of claim 1, wherein the premium is collected in equal payments through the time period.

7. The method of insuring a wedding of claim 1, wherein the premium decreases periodically through the time period.

8. The method of insuring a wedding of claim 1, wherein the trigger is at least one of a divorce, dissolution and annulment of the two people.

9. The method of determining a premium for wedding insurance comprising:
determining a probability of divorce of two people, who's wedding is being insured;
determining the amount of wedding insurance coverage;
determining a payment schedule for payment of the premium.

10. The method of insuring a wedding of claim 9, wherein the premium is collected as a flat fee before the wedding.

11. The method of insuring a wedding of claim 9, wherein the premium is collected as a flat fee after the wedding.

12. The method of insuring a wedding of claim 9, wherein the premium is collected in equal payments through the time period.

13. The method of insuring a wedding of claim 9, wherein the premium decreases periodically through the time period.

14. The method of insuring a wedding of claim 9, wherein the probability of divorce is at least partially determined according to the age, number of children present in a relationship, previous divorces, history of abuse, criminal records, religious affiliation, ethnicity, net worth, income, debt, mental and physical health of the two people.

15. The method of insuring a wedding of claim 9, wherein the wedding insurance covers expense relating to at least one of, a church, reception hall, catering services, wedding cake, pictures, transportation services, rehearsals, invitations, gifts, dresses, suits and tuxedos, entertainment, flowers and decorations.

16. A system for determining a wedding insurance premium amount comprising:
a computer program configured to receive, as input, an amount of wedding insurance coverage and a payment schedule for payment of a premium;
wherein the computer program is configured to receive factors that may affect a probability of divorce of two people, who's wedding is being insured.

17. A system for determining a wedding insurance premium amount of claim 16, wherein the computer program is configured to process the factors and calculate a probability of divorce.

18. A system for determining a wedding insurance premium amount of claim 17, wherein the computer program is configured to process the probability, the amount of coverage of wedding insurance and the payment schedule for payment of a premium and calculate the premium amount.
